(19) United States
(12) Patent Application Publication
(10) Pub. No.: US 2014/0205237 A1
(43) Pub. Date: Jul. 24, 2014

(54) MECHANICALLY ALIGNED OPTICAL ENGINE

(71) Applicants: Sagi Varghese Mathai, Berkeley, CA (US); Michael Renne Ty Tan, Menlo Park, CA (US); Paul Kessler Rosenberg, Sunnyvale, CA (US); Wayne V. Sorin, Mountain View, CA (US); Georgios Panotopoulos, Berkeley, CA (US); Susant K. Patra, Brentwood, CA (US)

(72) Inventors: Sagi Varghese Mathai, Berkeley, CA (US); Michael Renne Ty Tan, Menlo Park, CA (US); Paul Kessler Rosenberg, Sunnyvale, CA (US); Wayne V. Sorin, Mountain View, CA (US); Georgios Panotopoulos, Berkeley, CA (US); Susant K. Patra, Brentwood, CA (US)

(21) Appl. No.: 14/342,705

(22) PCT Filed: Sep. 6, 2011
(86) PCT No.: PCT/US2011/050551

§ 371 Date: Mar. 4, 2014

(51) Int. Cl. G02B 6/42

(52) U.S. Cl. CPC G02B 6/4204; G02B 6/4231; G02B 6/4239; G02B 6/4238
USPC 385/33; 29/407.09

(57) ABSTRACT

A mechanically aligned optical engine includes an optoelectronic component connected to a first side of a bench substrate and a transparent substrate bonded to a second side of the bench substrate. The transparent substrate comprises a mechanical feature designed to fit within an aperture of the bench substrate such that a lens formed onto the transparent substrate is aligned with an active region of the optoelectronic component.

### BACKGROUND

Optical engines are commonly used to transfer electronic data at high rates of speed. An optical engine includes hardware for transferring an electrical signal to an optical signal, transmitting that optical signal, receiving the optical signal, and transforming that optical signal back into an electrical signal. The electrical signal is transformed into an optical signal when the electrical signal is used to modulate an optical source device such as a laser. The light from the source is then coupled into an optical transmission medium such as an optical fiber. After traversing an optical network through various optical transmission media and reaching its destination, the light is coupled into a receiving device such as a detector. The detector then produces an electrical signal based on the received optical signal for use by digital processing circuitry.

The mechanism for coupling an optical transmission medium to either a source device or a receiving device is typically done through a process called active alignment. Active alignment typically involves a lens system to direct light from a source device into an optical transmission medium or to direct light from the optical transmission medium to a receiving device. Active alignment utilizes a feedback signal to adjust the physical location of key components that can be time consuming. The lens system must be carefully aligned to maximize the coupling of optical power from the source to the optical medium and back to the detector during manufacture. This process is both time consuming and costly. Additionally, the lenses used in the lens system can be costly.

### BRIEF DESCRIPTION OF THE DRAWINGS

The accompanying drawings illustrate various examples of the principles described herein and are a part of the specification. The drawings are merely examples and do not limit the scope of the claims.

FIG. 1 is a diagram showing an illustrative optical communication system, according to one example of principles described herein.

FIG. 2 is a diagram showing an illustrative optical engine mechanically aligned with an optical transmission medium, according to one example of principles described herein.

FIG. 3 is a diagram showing an illustrative optical engine array mechanically aligned with an optical transmission medium array, according to one example of principles described herein.

FIG. 4 is a diagram showing an illustrative top view of a lens array formed into a transparent substrate, according to one example of principles described herein.

FIGS. 5A-5D are diagrams showing illustrative steps of a process to form alignment structures for an optical engine, according to one example of principles described herein.

FIGS. 6A-6B are diagrams showing further illustrative steps of a process to form a mechanically aligned optical engine, according to one example of principles described herein.

FIG. 7 is a diagram showing alignment for a connection of an optical transmission medium connector to a transparent substrate, according to one example of principles described herein.

FIG. 8 is a flowchart showing an illustrative method for mechanical optical engine alignment, according to one example of principles described herein.

Throughout the drawings, identical reference numbers designate similar, but not necessarily identical, elements.

### DETAILED DESCRIPTION

As mentioned above, the mechanism for coupling an optical transmission medium to either a source device or a receiving device is typically done through a process called active alignment. This active alignment can be time consuming and costly. Due to this cost, optical systems are typically used for telecommunication systems and data communication systems. Telecommunication systems often involve the transmission of data over geographic distances ranging from a few miles to thousands of miles. Data communications often involve transmission of data throughout a datacenter. Such systems involve the transmission of data over distances ranging from a few feet to several hundred feet.

The use of optical transmission systems in computer communication systems would benefit from the high bandwidth provided by such optical systems. Bandwidth refers to the amount of data that can be transmitted within a specified unit of time. However, computer communication systems typically involve the transmission of data over smaller distances that range from a few inches to several feet. Thus, it is often not economically practical to use the more expensive optical coupling components to optically transmit data over such small distances.

In light of this and other issues, the present specification discloses methods and systems for mechanically aligning an optical engine to an optical transmission medium. According to certain illustrative examples, a transparent substrate is bonded to a bench substrate. The transparent substrate may be made of a material such as glass or plastic and the bench substrate may be made of a semiconductor material such as silicon. Alternatively, the bench substrate may be made of a metallic material such as nickel or a plastic material. The bench substrate includes an aperture whereby light is able to pass between an optoelectronic component attached to one side of bench substrate and the transparent substrate bonded to the other side of the bench substrate.

One or more lenses are formed into the transparent substrate. These lenses are used to couple light passed through the aperture into an optical transmission medium connected to the opposing side of the transparent substrate. These lenses must be precisely aligned so that light will be efficiently coupled between the optoelectronic component and the optical transmission medium. In order to align these lenses, a mechanical alignment feature is formed into the transparent substrate. This alignment feature is designed to precisely fit into the aperture in the bench substrate. In some cases, the lens itself may act as the alignment feature. The lenses formed into or on the transparent substrate may be refractive, diffractive, or high contrast grating lenses.

The optoelectronic component includes either a transmission device such as a laser or a receiving device such as a photodiode. The optoelectronic component can be precisely aligned to the aperture through a solder reflow process. More detail on this solder reflow process will be discussed below. With both the optoelectronic component and the lens precisely aligned, light will pass through the aperture and be focused into the optical transmission medium placed against the opposing side of the transparent substrate. In the case of a photodiode precisely aligned to the lens, light from the optical transmission medium will pass through the aperture and focus onto the photodiode. Various other mechanical alignment features may be used to secure the optical transmission medium to the opposing side of the transparent substrate.

Through use of methods and systems embodying principles described herein, a simple and less costly manner of aligning an optoelectronic component to an optical transmission medium is realized. No active alignment process has to take place. This less costly manner of alignment can make it more economical to use optical transmission systems for computer communications.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with that example is included as described, but may not be included in other examples.

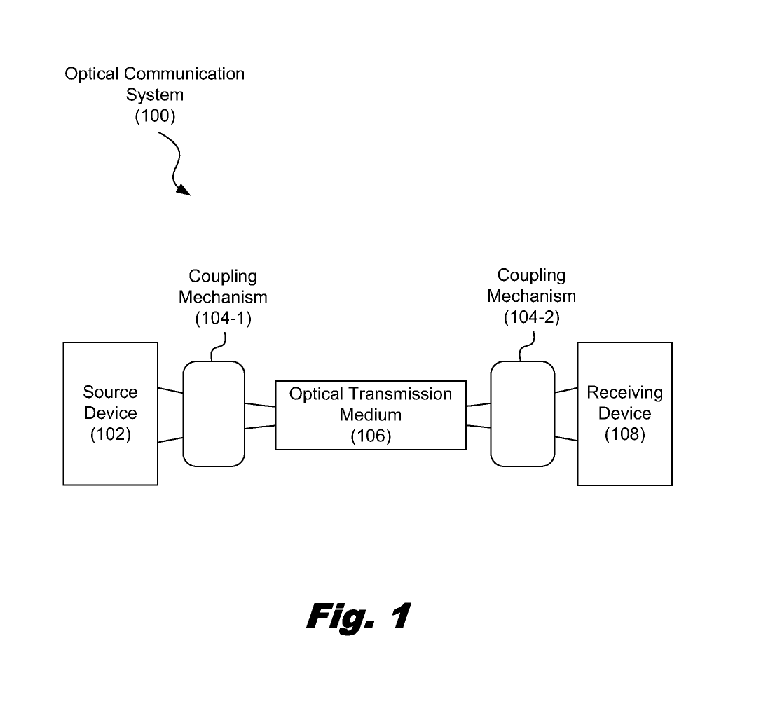

Referring now to the figures, FIG. 1 is a diagram showing an illustrative optical communication system (100). According to certain illustrative examples, an optical communication system includes a source device (102), coupling mechanisms (104), an optical transmission medium (106), and a receiving device (108).

A source device (102) is an optical transmitter that projects a beam of light capable of being modulated so as to transmit data. A source device (102) may convert an electrical signal into an optical signal by using the electrical signal to modulate a light source. Examples of light sources which may be used in an optical communication system include Light Emitting Diodes (LEDs) and lasers. One type of laser that can be used is a Vertical-Cavity Surface-Emitting Laser (VCSEL).

A VCSEL is a laser that projects light perpendicular to the plane of a semiconductor substrate. A semiconductor substrate may include a two dimensional array of VCSELs. Each VCSEL may be modulated by a different electrical signal and thus each VCSEL within the array can transmit an optical signal carrying a different channel of data. In order to transmit the optical signals through light produced by the VCSELs, the light is focused or collimated by a coupling mechanism (104-1) such as a lens into an optical transmission medium (106) such as an optical fiber or hollow metal waveguide.

An optical transmission medium (106) such as an optical fiber is a medium that is designed to provide for the propagation of light. An optical fiber may bend and the light will still travel through from one end of the fiber to the other. An optical fiber typically includes two different types of material. The core of the fiber is typically a transparent material. A transparent cladding material is formed around the core of the fiber. The cladding material has an index of refraction that is slightly less than the index of refraction of the core material. This causes light that is projected into the core to bounce off the sides of the core towards the center of the core. Thus, the light will propagate down the entire length of the optical fiber and emerge at the other end. In order to get the light to propagate through the optical fiber correctly, the light has to be focused properly by the coupling mechanism (104-1).

When light propagating through the optical transmission medium (106) reaches the opposite end, a coupling mechanism (104-2) will focus the light onto a receiving device (108) such as a photodetector. A photodetector may convert a received optical signal into an electrical signal by generating an electrical signal according to the received optical signal. As will be described in more detail below, the coupling mechanism (104-2) can act as a demultiplexer and separate the multiple wavelengths of light so that they are received by different detectors.

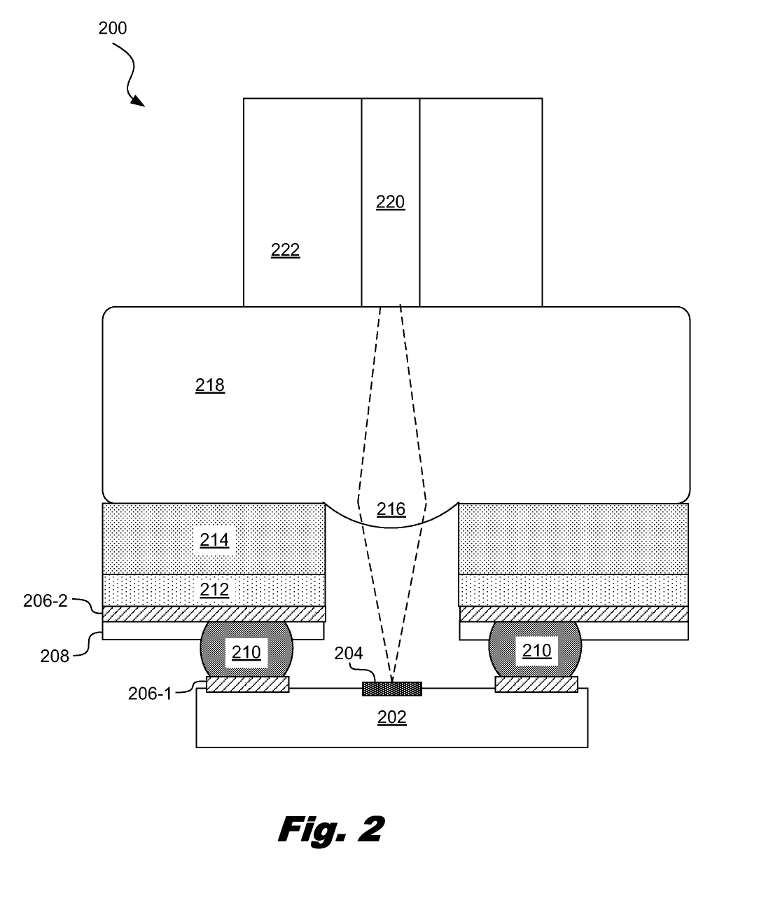

FIG. 2 is a diagram showing an illustrative optical engine (200) with an optoelectronic component (202) mechanically aligned with an optical transmission medium (220). According to certain illustrative examples, the optoelectronic component (202) is connected to the bench substrate (214) using a solder reflow process. The solder reflow process is designed such that an active region (204) of the optoelectronic component is aligned with an aperture within the bench substrate (214). Additionally, a transparent substrate (218) is bonded to the other side of the bench substrate (214). The transparent substrate is positioned such that a lens (216) formed into the substrate is aligned with the aperture in the bench substrate. The placement of the lens (216) as well as the active region (204) of the optoelectronic component (202) is such that light is coupled between the lens (216) and the active region (204). The lens may be either a diffractive lens, a refractive lens, or a high contrast grating lens.

The solder reflow process used to connect the optoelectronic component (202) to the bench substrate (214) involves the use of specifically sized metallic contacts (206). A first set of metallic contacts (206-1) is formed onto the optoelectronic component itself. A second set of metallic contacts (206-2) is formed onto the bench substrate (214). In one example, a passivation layer (208) is formed on top of a metallic layer formed at the bottom of the bench substrate (214). Specific regions can then be removed from the passivation layer (208) to expose metal contacts.

Solder bumps are then placed between the first set of metallic contacts (206-1) and the second set of metallic contacts (206-2). These metallic contacts may be connected to electrical traces on the substrate (214) and optoelectronic component (202). The volume, shape, and composition of the solder bumps is precisely chosen so that when the solder is reheated and cooled, it pulls the metallic contacts (206) into alignment with each other. The spacing and location of the metallic contacts on both the optoelectronic component (202) and the bench substrate (214) is such that when the solder cools, the active region (204) of the optoelectronic component is properly placed. The proper placement of the active region (204) is where light being emitted from or collected by that active region is efficiently coupled with a lens (216) formed into the transparent substrate. The lens itself will also be aligned to the proper place so that light will efficiently travel between the lens (216) and the active region (204).

In the case that the optoelectronic component (202) is a transmitting device, the active region (204) is the portion that emits light. This light is modulated according to an electrical signal such that the data within that signal is transmitted as an optical signal through the optical transmission medium (220). In the case that the optoelectronic component (202) is a receiving device, then the active region is the portion that collects an optical signal that is then used to create an electrical signal. In order for the optical signal to be effectively transferred to or received from the optical transmission medium (220), the light has to be appropriately focused by a precisely placed lens (216).

Instead of using an active alignment process to place the lens, the transparent substrate (218) out of which the lens is formed may include mechanical alignment feature. A mechanical alignment feature may be a bump or some other obtrusive formation on either the bench substrate (214) or the transparent substrate (218). The alignment feature of one substrate is designed to fit into a corresponding feature of the other substrate. For example, the lens (216) itself may be used as an alignment feature. The lens can be designed such that the outer boundaries of the lens (216) fit precisely into the aperture in the bench substrate (214). The sizing of the aperture and the alignment feature are such that the lens (216) will be placed at the appropriate spot when the transparent substrate (218) is bonded to the bench substrate (214). When the lens is placed at the appropriate spot, it will efficiently focus light from the active region (204) into the optical transmission medium (220).

The optical transmission medium (220) may be an optical fiber embedded within a cable and secured to a connector (222). The connector (222) may hold one or more optical fibers. Various alignment features may be used to secure the connector (222) to the transparent substrate (218) so that the core of the optical fiber is aligned with the region where the lens (216) will focus light. The optical transmission medium (220) may be in direct contact with the transparent substrate (218). In some examples, the optical transmission medium (220) may be offset from or recessed into the transparent substrate (218). The connector may be permanently attached or designed to be detachable. In the case of a permanent attachment, the connector can be minimally designed without other features such as a latching mechanism.

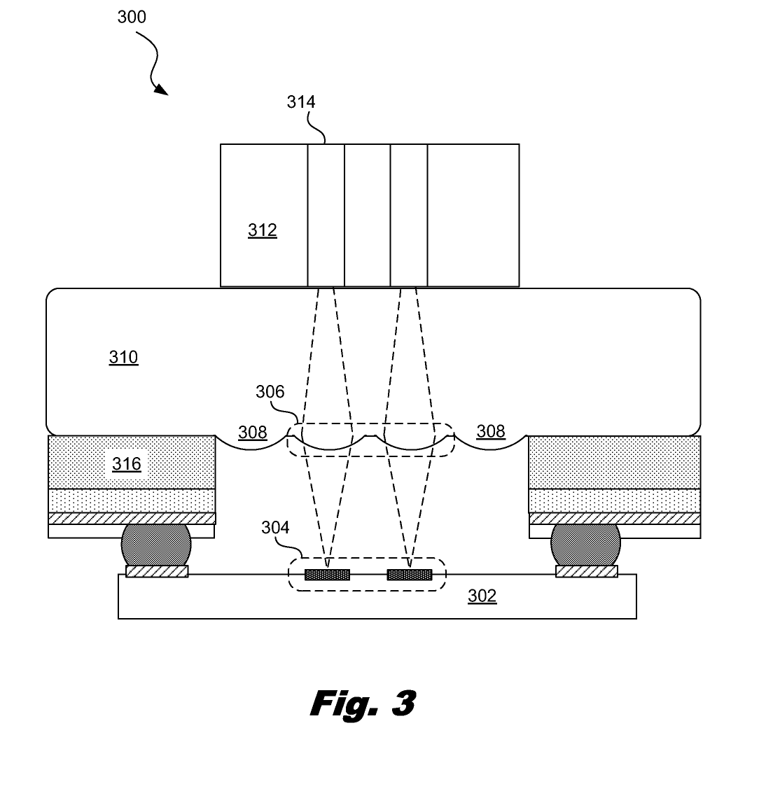

FIG. 3 is a diagram showing an illustrative optical engine array mechanically aligned with an optical transmission medium array. According to certain illustrative examples, an aperture may be wide enough to allow several beams of light pass between a lens array (306) and an active region array (304). In some examples, multiple apertures may be wide enough to allow individual beams of light or groups of beams of light to pass between a lens array (306) and an active region array (304)

In one example, the transparent substrate (310) includes an alignment feature array. The boundaries of the aperture within the bench substrate (316) may be designed to match the outer boundaries of the outer alignment features (308). In this example, the outer alignment features (308) are only used for aligning purposes and not as lenses. However, in some cases, the outer alignment features may be used as lenses.

The optoelectronic component (302) includes an array (304) of active regions. The spacing within the array (304) is designed to match the spacing of the lenses within the lens array (306). When the optoelectronic component is properly aligned with the aperture using the solder reflow process, the active regions will be precisely aligned with the lenses within the lens array (306). The lenses may then focus the light to an array of optical fibers (314) secured to a connector (312).

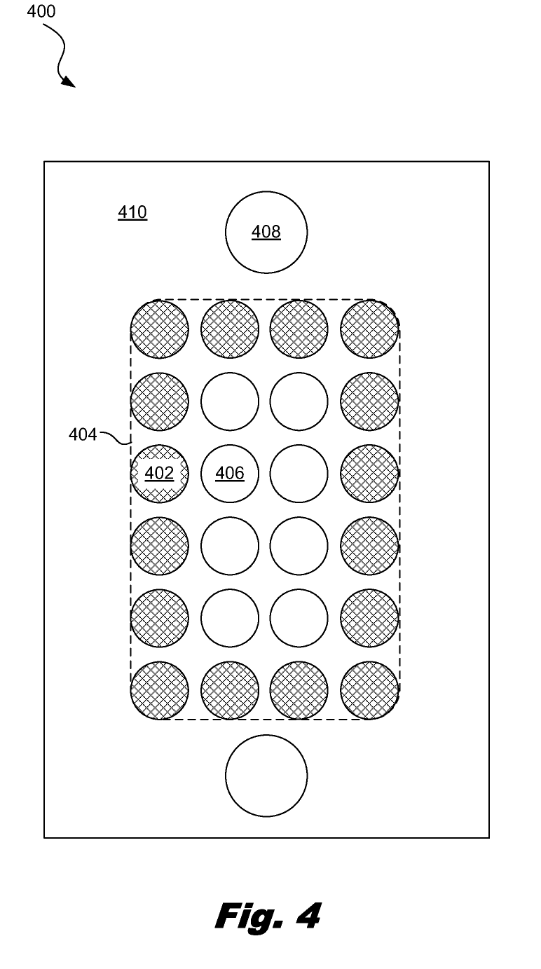

FIG. 4 is a diagram showing an illustrative top view of a lens array (400) formed into a transparent substrate (410). According to certain illustrative examples, a two-dimensional array of alignment features may be used to align the transparent substrate (410) properly against the bench substrate. The dotted line (404) represents the outer boundary of the outer alignment features (402). The aperture formed into the bench substrate is formed to match this outer boundary. Thus, the array of alignment features fits into that aperture. The transparent substrate (410) may also include additional alignment features (408) such as obtrusions or holes that are used to connect and align an optical transmission medium to the transparent substrate. The alignment features (408) used to align the connector are precisely registered to the alignment features (402) used to align the transparent substrate (410) to the bench substrate.

The alignment features (402, 406) may also be used as lenses. In some cases, only the inner alignment features (406) are used as lenses while the outer alignment features (402) are only used for alignment purposes. As the process used to form the lenses is often the same process used to form the alignment features, the alignment features (402) may still be shaped as lenses whether or not they are used as such. This simplifies the process of manufacturing the transparent substrate. In some examples, the alignment features (402, 406) may be a single continuous feature such as a wall, island, or recessed feature.

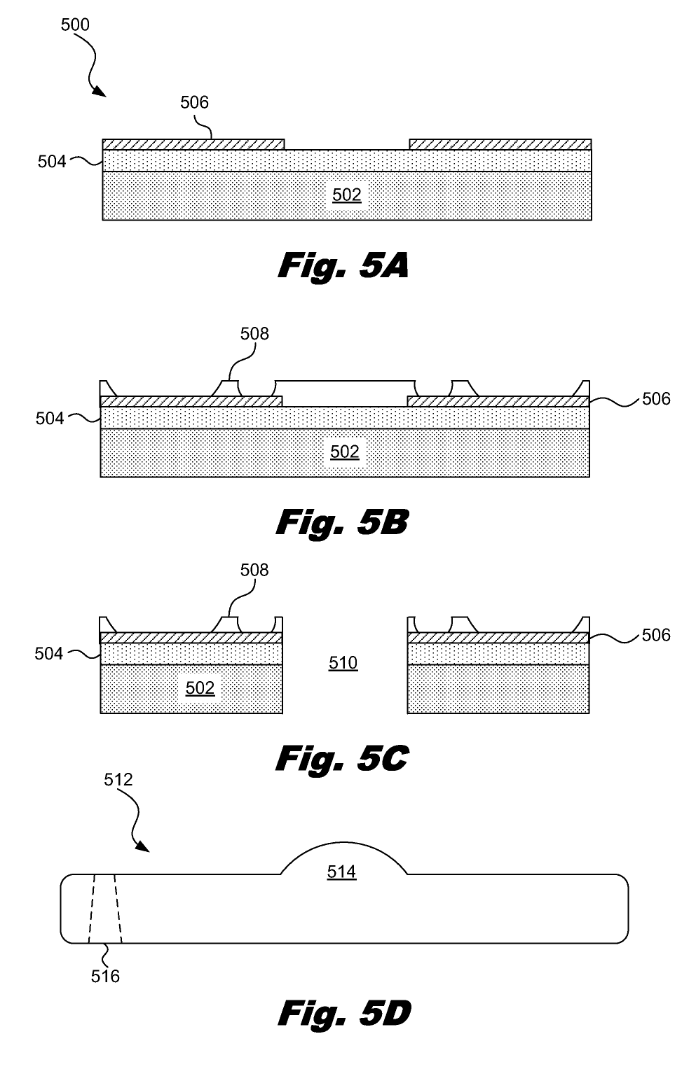

FIGS. 5A-5D are diagrams showing illustrative steps of a process to form alignment structures for an optical engine. FIG. 5A is a diagram showing an illustrative bench substrate (500) that includes a semiconductor layer (502), a dielectric layer (504), and a metallic layer (506). The semiconductor layer is made of a semiconductor material such as silicon. The dielectric material is a non-conductive material such as silicon dioxide. The purpose of the dielectric layer is to prevent electric currents which are passing through the metallic layer (506) from leaking into the semiconductor layer (502). In some cases, a highly resistive semiconductor material may be used in place of both the semiconductor layer (502) and the dielectric layer (504).

FIG. 5B is a diagram illustrating the deposition and etching of a passivation layer (508). The passivation layer may be a dielectric material that is deposited on top of the metallic layer (506). Then, using a photolithographic process, certain regions of the passivation layer (508) are etched away to expose the metallic layer (506) underneath. These exposed regions are where solder bumps for the solder reflow process are to be placed.

FIG. 5C is a diagram of the bench substrate (500) after an aperture (510) has been formed through that substrate (500). This aperture may be formed using various etching processes. As mentioned above, this aperture is used to pass light between an active region of an optoelectronic component and a lens that focuses that light into an optical transmission medium.

FIG. 5D is a diagram showing an illustrative transparent substrate (512) that is bonded to the bench substrate (500). The transparent substrate (512) includes an alignment feature that may be used as a lens. In some cases, alignment features which are not used as lenses may also be formed around the lenses. In one example, the lenses and alignment features may be formed using a dry etch process. Other methods may be used to form the lenses including, but are not limited to, stamping, photoresist reflow, injection molding, and compression molding.

A connector alignment feature (516) may also be formed into the transparent substrate (512). This connector alignment feature (516) is used to allow the optical transmission medium connector to align itself to the transparent substrate such that light being focused by the lens is placed into an optical fiber within the optical transmission medium connector. One example of such an alignment feature may be a pinhole. In some cases, the pinhole may be used to provide coarse alignment of the connector. Coarse alignment refers to an alignment that brings the connector into the approximate region of where it needs to ultimately be placed. The pinhole may be formed, for example, by a sandblasting process.

A corresponding pinhole may be formed in the bench substrate (500). The pinhole in the bench substrate (500) is registered to the exposed metallic layer (506) to provide precise alignment of the connector to the optoelectronic components. Precise alignment refers to an alignment that brings the connector into the precise position that will effectively allow light from the active region of the electro-optical components to couple into the transmission media within the connector. In some examples, the pin may be incorporated into a printed circuit board that is used to hold the optoelectronic components. Alternatively, the pin may be temporarily attached to the printed circuit board and configured to mate with holes in the bench substrate, transparent substrate, and connector. The connector may be a detachable connector or one that is designed to be permanently attached to the optoelectronic system.

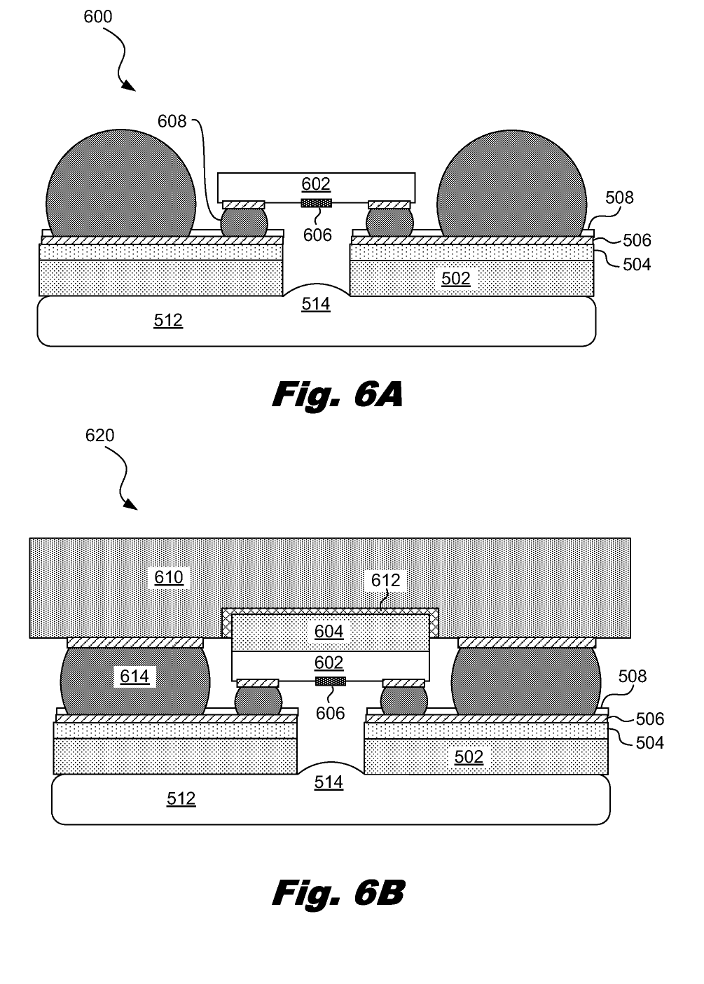

FIGS. 6A-6B are diagrams showing further illustrative steps of a process to form a mechanically aligned optical engine. According to certain illustrative examples, the transparent substrate (512) is bonded to the semiconductor layer (502) of the bench substrate. Various bonding methods may be used including, but not limited to, anodic bonding, thermal compression, and gluing. As mentioned above, the lenses within the transparent substrate will be appropriately aligned due to the mechanical alignment features formed into the transparent substrate. These mechanical alignment features are specifically placed so that when placed into the appropriate aperture of the bench substrate, the lenses will be appropriately aligned.

In order to secure the optoelectronic component to the opposing side of the aperture, solder bumps are placed onto the exposed regions of the metallic layer (506). The optoelectronic component (602) itself includes a set of solder pads or pads with under-bump metallization. These pads are designed with a specific volume, shape and composition and a specific placement such that when they are placed onto the solder bumps (608) and the solder reflow process is applied, then the flip chipped optoelectronic component will be pulled into precise alignment. This precise alignment is such that the active region (606) of the optoelectronic component is aligned with the lens (514) formed into the transparent substrate (512).

FIG. 6B is a diagram showing an illustrative process of connecting the optical engine to a printed circuit board. According to certain illustrative examples, larger solder bumps (614) may be placed onto larger exposed regions of the metallic layer (506). Additionally, a heat sink material (604) may be placed on top of the optoelectronic component. The heat sink prevents the optoelectronic component from overheating. In some cases, a thermal conductive material (612) may be placed on top of the heat sink (604) and between the heat sink and the optoelectronic component (602).

The printed circuit board (610) includes a set of metallic bond pads for placement onto the larger solder bumps (614). The solder reflow process then connects the bench substrate (502) to the proper place along the printed circuit board (610). In some cases, the printed circuit board may include a small cavity or through-hole in which the heat sink for the optoelectronic component (604) sits. In other examples, the solder bumps (614) may be placed onto the printed circuit board (610) rather than the bench substrate (500). In some cases, a ceramic substrate or flex circuit may be used instead of a printed circuit board.

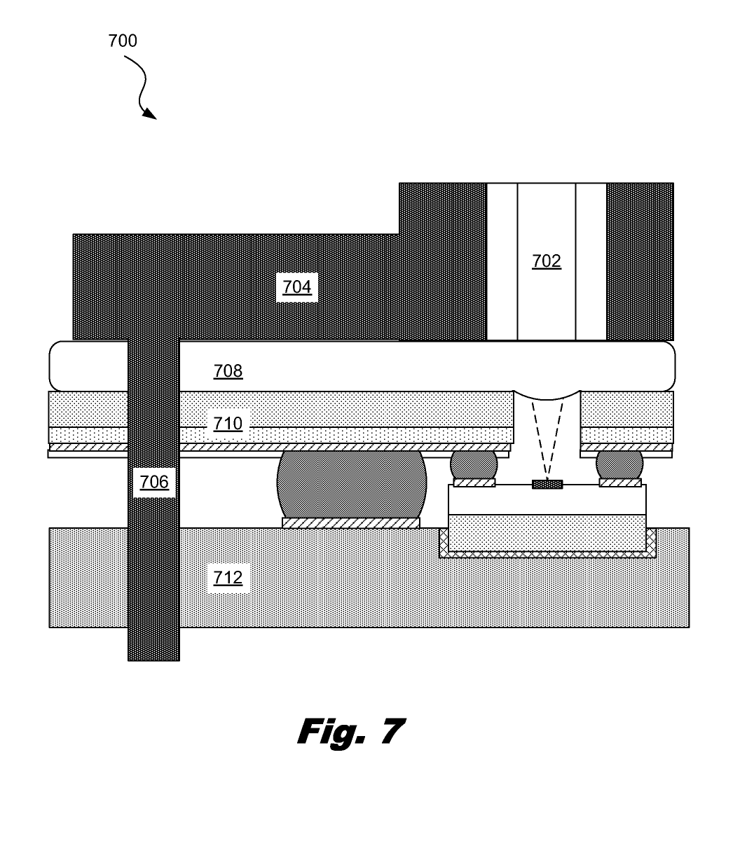

FIG. 7 is a diagram showing alignment (700) for a connection of an optical transmission medium connector (704) to a bench substrate (710) bonded to a transparent substrate (708). According to certain illustrative examples, the optical transmission medium connector (704) includes an alignment feature such as a pin (706). This pin is designed to fit into holes formed through the glass substrate (708), the bench substrate (710), and into the printed circuit board (712). The positioning of the pin (706) and holes are such that when the pin is placed in the hole, the optical transmission medium (702) within the connector (704) is precisely aligned. When precisely aligned, the light being focused by the lens will couple properly into the optical transmission medium (702).

For example, the pin may be registered to a hole in the substrate (710) that is precisely aligned to the aperture in the substrate (710). Precise alignment between these features and other features on the substrate can be achieved by photolithography. In this case, the hole in the transparent substrate (708) can be oversized to provide coarse alignment. The shape of the holes can be conical, cylindrical, or a combination of the two. This alignment scheme can be used to achieve a pigtailed connection or a detachable connection.

The alignment feature illustrated in FIG. 7 is merely one example of how the optical transmission medium connector (704) may be connected to the transparent substrate (708). The pin can be an integral part of the connector or a separate part inserted into a precision hole in the connector body. In some cases, the transparent substrate (708) may include obtrusions that fit into holes within the connector. Any method of connection that allows the optical transmission medium to be placed flush against or offset from the transparent substrate (708) and aligned properly may be used. The examples described herein for methods of alignment are merely illustrative methods. Several other methods for providing alignment between the connector and the transparent substrate may be used in accordance with the principles described herein.

The principles described herein are amenable to batch processing. Particularly, the bench substrate and transparent substrate may be formed and bonded as wafers. These wafers may be later cut accordingly into individual components. Such batch processes provide more cost effective methods of manufacturing.

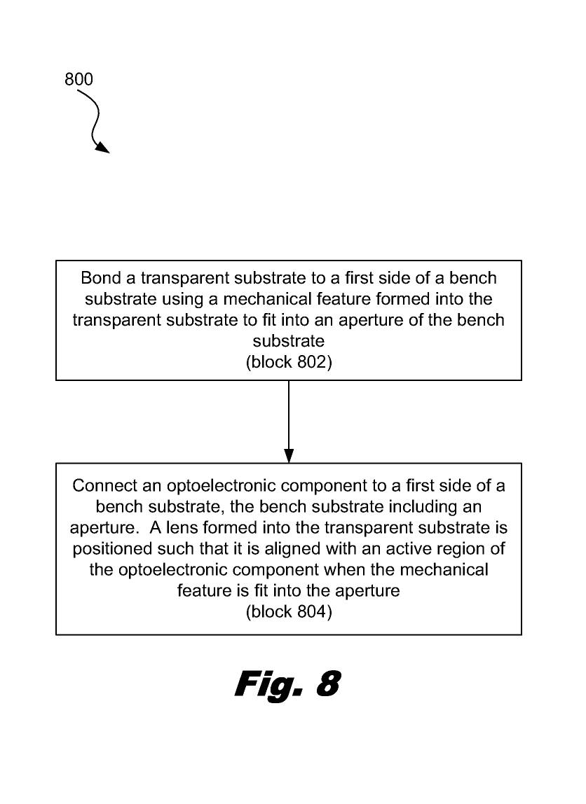

FIG. 8 is a flowchart showing an illustrative method for mechanical optical engine alignment. According to certain illustrative examples, the method includes wafer bonding (block 802) a transparent substrate to a first side of the bench substrate using a mechanical feature formed into the transparent substrate to fit into an aperture of the bench substrate, and connecting (block 804) an optoelectronic component to a second side of the bench substrate. A lens formed into the transparent substrate is positioned such that it is aligned with an active region of the optoelectronic component when the mechanical feature is fit into the aperture.

In conclusion, through use of methods and systems embodying principles described herein, a simple and less costly manner of aligning an optoelectronic component to an optical transmission medium is realized. No active alignment process has to take place. This less costly solution can make it more economical to use optical transmission systems for computer communications.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A mechanically aligned optical engine comprising:
an optoelectronic component connected to a first side of a bench substrate; and
a transparent substrate bonded to a second side of said bench substrate;
wherein said transparent substrate comprises an alignment feature designed to fit within an aperture of said bench substrate such that a lens formed onto said transparent substrate is aligned with an active region of said optoelectronic component.

2. The optical engine of claim 1, wherein said aperture is such that light is allowed to pass between said lens and said active region.

3. The optical engine of claim 1, wherein said lens comprises said alignment feature.

4. The optical engine of claim 1, wherein at least one of said bench substrate and said transparent substrate comprises a connector alignment feature to fit an optical transmission medium connector in relation to said transparent substrate, said optical transmission medium connector being aligned such that light passed between said lens and said active region is directed into an optical transmission medium of said optical transmission medium connector.

5. The optical engine of claim 4, wherein said connector alignment feature comprises one of: a pin and hole connection between said optical transmission medium connector and said transparent substrate and obtrusions formed into said transparent substrate, said obtrusions precisely fitting into holes formed into said connector and said bench substrate.

6. The optical engine of claim 1, wherein said lens is one of an array of lenses formed onto said transparent substrate and positioned such that said light passes between said lenses and an array of active regions on said optoelectronic component.

7. The optical engine of claim 1, wherein said bench substrate comprises one of: a silicon-on-insulator and doped silicon material, and a high resistivity semiconductor material.

8. The optical engine of claim 1, wherein said lens comprises one of: a refractive lens, a diffractive lens, and a high contrast grating lens.

9. A method for mechanically aligning an optical engine, the method comprising:
bonding a transparent substrate to a first side of said bench substrate using an alignment feature formed into said transparent substrate to fit into an aperture of said bench substrate; and
connecting an optoelectronic component to a second side of said bench substrate;
wherein a lens formed into said transparent substrate is positioned such that it is aligned with an active region of said optoelectronic component when said alignment feature is fit into said aperture.

10. The method of claim 9, wherein said lens comprises said alignment feature.

11. The method of claim 9, further comprising, connecting an optical transmission medium connector to said at least one of said bench substrate and said transparent substrate using a connector alignment feature, said connector connector alignment feature positioned so that light passing between said lens and said active region is directed into an optical transmission medium of said optical transmission medium connector.

12. The method of claim 8, wherein said lens is one of an array of lenses formed onto said transparent substrate and positioned such that said light passes between said lenses and an array of active regions on said optoelectronic component.

13. The method of claim 8, further comprising, connecting said bench substrate to one of: a printed circuit board, a ceramic substrate, and a flex circuit using a flip-chip process.

14. The method of claim 8, wherein connecting said optoelectronic component to said first side of said bench substrate comprises a solder bump reflow process.

15. A mechanically aligned optical engine comprising:
an optoelectronic component connected to a first side of a bench substrate, said optoelectronic component comprising an array of active regions; and
a transparent substrate bonded to a second side of said bench substrate, said transparent substrate comprising an array of alignment features;
wherein an outer boundary of outer alignment features of said array of alignment features positioned to fit within an aperture of said bench substrate such that inner alignment features acting as lenses are aligned with said array of active regions.
